(19) United States
(12) Patent Application Publication
(10) Pub. No.: US 2009/0148399 A1
(43) Pub. Date: Jun. 11, 2009

(54) Controlled release attractant for gravid female mosquitoes

(76) Inventor: James Robert Bette, Athens, GA (US)

Correspondence Address: James R. Bette, 145 Biscayne Drive, Athens, GA, 30606, US

(21) Appl. No.: 11/999,975

(22) Filed: Dec. 7, 2007

(51) Int. Cl. A01N 25/00

(52) U.S. Cl. 424/84

(57) ABSTRACT

One or a combination of known chemical cues that attract pregnant female mosquitoes to an egg-laying site are embedded in a biodegradable carrier that releases the compound at a generally constant rate for up to a year or longer. The compound is useful for attracting large numbers of mosquito vectors to a site where they and their progeny can be eliminated.

### CROSS-REFERENCE TO RELATED APPLICATIONS

Provisional patent application No. 60/814,811 filed Jun. 19 2006 Regular patent application Ser. No. 11/809,936 filed Jun. 6, 2007

### STATEMENT REGARDING FEDERALLY SPONSORED RESEARCH AND DEVELOPMENT

Not Applicable

### SEQUENCE LISTING OR PROGRAM

Not Applicable

### BACKGROUND OF THE INVENTION

1. Field of the Invention

This invention relates to a controlled release compound for a substance known to attract gravid (pregnant) female mosquitoes to a breeding site, where they and/or their progeny can then be eliminated.

2. Background and Related Art

Gravid female mosquitoes must be able to find suitable sites for depositing their eggs to insure the continuation of the species. Evidence indicates that one indicator in her decision making process is triggered by habitat related semio-chemicals (behavior changing chemicals), or pheromones, and this knowledge can be exploited to produce ovitraps (egg laying strata) for monitoring and control. Laurence, B. R. and Pickett, J. A. (1985) Bull.Ent.Res. 75; 283-290 discovered that the mosquito Culex quinquefasctatus, vector for West Nile Virus, Encephalitis, Lymphatic Filariasis, and a host of other debilitating and sometimes deadly diseases, produces the pheromone heterocyclic diasteroisomeric lactone mixture, (5R,6S)-6-acetetoxy-5-hexadecanolide which volatizes from the tips of this species' eggs, formed in floating egg rafts, over a 48 hour period after she deposits them. This pheromone attracts other females of the same species to deposit their eggs gregariously in the same larval habitat. Similarly, the compound 3-Methyl indole, also known as Skatole, a malodorous compound that signals organic enrichment, is a highly effective attractant to gravid female C. quinquefasciatus (Arthropod Semiochemicals; Mosquitos, Midges and Sea Lice, Biochem. Soc. Trans., 2001, 31, 128-133, A. J. Mordue Luntz). A subsequent study (Laboratory and Field Responses of the Mosquito Culex quinquefasciatus, to Plant-Derived Culex spp. Oviposition Pheromone and the Oviposition Cue Skatole, published by in the Journal of Chemical Ecology, 2004 May; 30(5): 965-76 by Olaghemiro T. O., Birkett M. A., Mordue Luntz A. J., Pickett J. A.) concluded that the attractancy of the two substances were, in some cases, synergistic ie; their combined attractancy was greater than their individual attractancies added together at certain concentrations, and that this synergistic result could be achieved by production of the pheromone from a renewable botanical source. The Vector Control Research Center in Pondicherry, India has identified the Secondary Metabolites of the fungus Trichoderma viride as also attractive for the ovipositing (egg laying) female Culex quinquefasciatus (Oviposition Response of the Mosquito, Culex quinquefasciatus to the secondary Metabolite(s) of the Fungus, Trichoderma viride, Mem. Inst. Oswaldo Cruz vol. 98 no. 2 Rio de Janeiro March 2003; I Geetha; K P Paily; V Padmanaban; K Balaraman). The same research center found that there is attractancy to gravid female Anopholes subpictus and Aedes aegypti from a wood inhabiting fungus (Oviposition Attractancy of an Infusion From a Wood Inhabiting Fungus for Vector Mosquitoes), Indian Journal of Medical Research, Jul. 1, 2001; 14:18-24; Sivagnaname N, Amaoraj D D, Kalyanasundaram M, Das P K. Investigators in India also found additional compounds to be attractive to ovipositing female Aedes aegypti in their study (Studies of Aedes Aegypti Ovipositional responses to Newly Identified Semiochemicals from Conspecific Eggs), Australian Journal of Entomology, 2006, 45, 75-80; Ganesan, Mendki, Suryanarayana, Prakash, Malhotra). In the United States, investigators at U.C. Riverside made several findings of compounds attractive to gravid mosquitoes, most notably in their study (Electroantennogram and Oviposition Bioassay Responses of Culex quinquefasciatus and Culex tarsalis to Chemicals in Odors from Bermuda Grass Infusions), Journal of Medical Entomology, 36(2): 158-166, (1999), Yong-Jun Du, Jocelyn G. Millar.

Laboratory experiments identified in the literature as well as the references cited above, in some cases, have shown gravid female mosquitoes to be over 10 times more likely to choose a site containing certain attractive semiochemicals than a similar site containing just water. Canyon (2001) in his study “Irritancy and repellancy of Aedes aegypti (Diptera: culicidae) to insecticides and implications for vector control operations”, concluded that many commercial larvicides, when used at the recommended saturation rates, have a repellant effect on ovipositing female mosquitoes. The inference is that once deployed, many of these compounds may have an immediate lethal effect on mosquitoes in the larval stages but can repel any further ovipositing females and drive them to find suitable sites that do not contain a larvicide, thus negating any long term benefits. He concluded “The challenge to industry is to develop a non-repellent insecticide with persistent attractant properties to address innate behavioral responses.” His study also found that some insecticides show attractancy when they are first deployed but over time, sometimes as little as several days, they then become repellant to ovipositing mosquitoes. The controlled release attractant that is the subject of this application seeks to reverse any repellancy characteristics of these compounds and instead attract ovipositing female mosquitoes to these sites.

U.S. Pat. No. 6,001,346 by M. Delwiche, J. M. Krochta, R. E. Rice, and C. Atterholt entitled Aqueous emulsion comprising biodegradable carrier and methods for controlled release thereof dated Dec. 14, 1999 describes a process of embedding the sex pheromone of the Oriental Fruit Moth in a sprayable form where it is then introduced into orchards and sprayed onto tree trunks. As the substance naturally bio-degrades over several months, the breeding period of the moths, the sex pheromone is continuously released, thereby confusing the males who cannot find a mate and the breeding cycle is thus interrupted.

### OBJECTS AND ADVANTAGES

Attractants developed to lure gravid female mosquitoes to a trap for scientific monitoring or breeding purposes all have the purpose of increasing the capture rate of these insects in a condensed period of time. The primary reason for this is to reduce the time spent in the field by investigators of all sorts, thereby reducing costs. Another tactic is to deploy species specific attractants so as to not have to deal with superfluous strains, thereby wasting investigative resources. The controlled release mechanisms described here bring these concepts out of the scientific arena and into a form usable for mass mosquito control worldwide in an environmentally friendly form. Accordingly, several objects and advantages of this invention are:
a.) To attract mosquitoes, and in particular mosquito vectors that spread infections and deadly diseases in humans, to a device where they and their progeny can be eliminated.
b.) To provide a substance for directing gravid female mosquitoes to a site where they can be controlled for up to a year or more.
c.) To provide a controlled release attractant that is species specific.
d.) To increase the efficiency of certain existing mosquito control products.
e.) To reduce the use of aerial spraying, misting and fogging systems that eliminate beneficial insects as well as mosquitoes.
f.) To provide a controlled release attractant for gravid female mosquitoes that requires no tending or other periodic maintenance, and that is biodegradable.

### DETAILED DESCRIPTION OF THE INVENTION

The current invention provides a composition for the continuous release of a pheromone or other attractant, or a pheromone combined with another substance, or another substance, or a combination of substances, known to attract ovipositing gravid female mosquitoes, from a carrier, for a period of up to one year or longer, and is combined with, or otherwise associated with, a device that will eliminate her progeny for an equal or greater lethally effective period of time. The composition is formed in such a manner that it can be placed in a likely mosquito breeding habitat such that when gravid mosquitoes deposit their eggs in the habitat, they will not reach maturity and be eliminated. The mosquito breeding habitat can either be water filled such as a No Maintenance Lethal Mosquito Breeding Trap, a catch basin, tire, or other container, or an area reasonably expected to become water filled in the future such as a dry pond, rut, or flood prone depressions. The release rate is adjustable and controllable by the optional addition of one or more additives to the carrier(s) and is calculated to last for up to one year or more. The carrier amalgamation may be formed into an emulsion, a paste, a wafer, an ingot, granules, powder, a coating or other forms and placed on or within the mosquito breeding habitat which may float on the water or sink partially or completely to the bottom. As the substance naturally bio-degrades or otherwise dissolves, dissipates, erodes or diffuses, the attractants that have been dispersed within are liberated to their surroundings and their scent is picked up by gravid female mosquitoes who follow the scent to its source and deposit their eggs. The amount of attractant is adjustable and variable as to the species being targeted and is calculated to be sufficient to provide attractancy for up to a year or more. A pesticide may be incorporated within this amalgamation or it may be separate from it. If a pesticide is not present at the attracting site, other means to control the insects should be employed.

The release rate of the attractant from the carrier and the period of time over which it is released is controlled by the selection of the carrier(s), by the respective concentrations of the carrier(s), by the type and concentrations of the attractant either singly or combinations thereof, by the physical properties and characteristics of the carrier/attractant combination, by the presence or absence of an additive such as antioxidants and/or volatility enhancers or suppressants, by the additives type and concentration, by the application conditions, by the weather, and by the season. Volatility suppressants or enhancers increase or decrease the release rate of the attractant(s). Antioxidants such as vitamin E increase the stability of the attractant(s) and slow its degradation and oxidation. Effervescents such as carbonates can bring submerged compounds to the surface.

The compound thus derived is versatile in that the employed variables allow preparation of compositions having a slow or fast release of large or small amounts of attractant at a more or less continuous and constant rate during the desired time period. For instance, if an attractant described herein were to be incorporated into a MOSQUITO DUNK™ manufactured by Summit Chemical Corp, it would be important to design the controlled release attractant to perform within a 3-4 week cycle since that is the window within which the larvicide BTI associated with this device remains lethal. Similarly, if included in a “No Maintenance Lethal Mosquito Breeding Trap”, the amalgamation should be designed to perform over a six month period if it is to be used during the mosquito season in North America, or alternately over a longer period if used in countries on or bordering the equator where mosquitoes breed year-round, and it should be designed to include a substance known to attract the mosquito specie being targeted. In no case should the attractant be designed to perform for a longer period of time than the time period within which the device it is used with, or incorporated into, remains lethal, as this condition could result in the breeding of mosquitoes.

All the above listed parameters are variable and their variation provides compositions having different release rates of various attractants. All variations of these properties are intended to be within the scope of the invention.

When the attractant is used with a No Maintenance Lethal Mosquito Breeding Trap it is possible to control the adult female as well as her progeny. Since the adult female will roost at the breeding site prior to and after depositing her eggs, by coating the possible roosting areas with an adulticide, she will contact the substance and eventually expire. Since adult females of most species will begin to seek another blood meal once a clutch of eggs has been laid, the ability to eliminate the adult, as well as her progeny, is an important advantage to a mosquito control device.

As noted, there are existing larviciding devices that contain a pesticide only whose efficiency could be significantly improved by the addition of the controlled release compound herein disclosed. Other existing trapping devices that do not contain an insecticide and instead rely on mechanical means to eliminate adult mosquitoes such as those described by Della Torre et al in their patent WO 2006/126235 dated Nov. 30, 2006, and Costantino in WO 03/007710 A1 dated Jan. 30, 2003, could also benefit by the addition of the controlled release compound herein disclosed, as it would attract adult gravid mosquitoes in greater numbers to these devices and thereby make them more efficient.

Primary Bioactive Attractants

Various attractants are suitable for use in the present invention. The term “attractant” as employed herein is intended to include without limitation, any compound, chemical, semiochemical, pheromone, kairomone, ketone, bacteria, fungus or combinations of these elements, that will induce a gravid female mosquito, of any species, to deposit her eggs in or around the source of the attractant in statistically significant greater numbers (above the margin of error) than a similar breeding site that does not contain an attractant. Attractancy as used herein may also be defined as that compound, or combination of compounds, that exhibit a positive Ovipositional Active Index (OAI) as suggested by Kramer and Mulla (1979) using the formula:

$$O A I = \frac{Nt - Ns}{Nt + Ns}$$

where Nt is the number of eggs (or egg rafts) laid in the test solution and Ns is the number of eggs (or egg rafts) laid in a control solution. Also as suggested by Kramer and Mulla (1979), compounds with an OAI of +0.3 and above are considered as attractants, while those with −0.3 and below are considered as repellants. Since the carrier(s) defined in this application release the attracting substance at a more or less constant rate, and can be programmed to function for up to a year or more, the attractancy levels thus described are the minimum levels achieved throughout an entire mosquito breeding season.

Some of the primary bioactive attractants of this invention, without limitation, are the pheromone heterocyclic diasteroiomeric lactone mixture, (5R,65)-hexadecanolide, 3-Methyl indole, lactone, epsilon-caprolactone, 6-hexanolactone, 6-pentyl-alpha-pyrone phenol, p-cresol, 4-ethylphenol, 4-methylphenol, indole, 3-methylindole, nonanal, 2-undecanone, 2-tridecanone, naphthalene, dimethyltrisulfide, dodecanoic acid, tetradecanoic acid, (Z)-9-hexadecanoic acid, hexadecanoic acid, (Z)-9-octadecanoic acid, octadecanoic acid, and n-heneicosane; the following bacteria/fungus group and their underlying chemical derivatives: enterobacter cloacae, acinitobacter calcoaceticus, psychrobacter immobilis, bacillus cereus, trichoderma viride, polyporus spp., aerobacter aerogenes, sphingobacterium multivorum, trichodermin, alamethicin, trichoviridin, and trichotoxin. These chemical cues, as a minimum, when released alone or in combinations and at certain concentrations, are attractive to gravid female mosquitoes, and in particular to genera of the Culex, Aedes, and Anopholes species, vectors of malaria, dengue and dengue hemorrhagic fever, lymphatic filariasis, west nile virus and encephalitis, to name a few, and induce these vectors to oviposit at the source. They may be added singly or in two or more combinations in amounts from 0.0001% to 40% by weight.

Pesticides:

Various pesticides are suitable for use in the present invention. The term “pesticide” as used herein is intended to include any active material used for the control of mosquitoes. Suitable pesticidal agents include, without limitation, larvicides, adulticides, biocides, fungicides, bacteria, viruses, insect growth regulators and ovicides. These pesticides may be incorporated within the controlled release carrier in combination with the attractants or may be associated but physically separate from them but, in any case, the time period in which the pesticide remains lethal will always be equal to or exceed the time period in which the attractant remains effective.

Pesticides or pesticidal agents include, without limitation, Temephos, Spinosad, malathion, DDT, pyretherin, BTI, permethrin, and insect growth regulators such as methoprene, S-methoprene, S-hydroprene, and S-kinoprene, insect pathogenic viruses, deltamethrin, cyfluthrin, cypermethrin, and lambdacyhalothrin. Because insect growth regulators are generally harmless to mammals and other sensitive beneficial insects, they are the preferred embodiment of this invention. Pesticides are added to the selected carrier in amounts from 0.0001% to 20%, preferably between 1%-5% by weight. Pesticides may be added singly or in combinations of two or more.

Carriers:

Examples of commercial attractant dispensers, or carriers, are microcapsules, trilaminates, capillaries, ropes (hollow tubes), and liquid flowables. These dispensers release their contents by evaporation from capillaries, by diffusion through a polymeric dispenser, or by diffusion through a microcapsule wall. The preferred embodiment of this application is a biodegradable carrier and that is what will be described in detail. Examples of biodegradable carriers of the invention, without limitation, are gypsum, plaster of paris, wax such as beeswax, lanolin, shellac wax, carnauba wax, fruit wax, candelilla wax, other waxes such as microcrystalline, ozocerite, ceresin, montan, polyethylene glycol sometimes called carbowax, charcoal, coal, or the preferred embodiment of this invention, paraffin and paraffin compositions able to form solid blocks or granules of an aqueous emulsion in amounts from 0.005%-100% by weight, or more preferably 40%-60% by weight into which the attractant(s) have been dispersed. The attractant(s) are released in a controlled and continuous manner as the carrier degrades by evaporation or dissolution or simply by normal molecular diffusion. These carriers may be used singly or in combinations of two or more.

Additives:

A variety of additives may be incorporated into amalgamations of the biodegradable carrier and attractant(s). These additives typically change and/or enhance the physical characteristics of the carrier material and are suitable for designing compositions having specific requirements as to the release rate and the amount of the released attractant(s), protection of the carrier composition against destruction by weather conditions, period of release (weeks, months, etc.), adding visual cues, adding buoyancy, etc. Such additives are, without limitation, plasticizers, volatility suppressants, antioxidants, various ultraviolet blockers and absorbers, antimicrobials, dark pigments such as black ink or vegetable dye, cork, perlite, and activated charcoal.

Antioxidents such as vitamin E, BHA, BHT, and others can protect the attractants from degradation and are added in amounts from 0.1% to about 3% by weight.

Emulsifiers such as lecithin and modified lecithins, mono and diglycerides, sorbitan monopalmitate, sorbitan monooleate, sorbitan monolaurate, polyoxyethylene-sorbitan monooleate, fatty acids, lipids, etc. provide or improve emulsification properties of the composition and are added in amounts from 1%-10% by weight.

Ultraviolet blockers such as beta carotene or p-aminobenzoic acid protect the components from light degradation and are added in amounts from 1% to about 3% by weight.

Antimicrobials such as potassium sorbate, nitrates, nitrites, and propylene oxide that protect the components from microbial destruction are added in amounts from 0.1% to about 2% by weight.

Plasticizers such as glycerin or soy oil affect physical properties of the composition and may extend its resistence to environmental degradation and are added in amounts from 0.5% to 4%.

Black ink, vegetable dye and other dark pigments improve visual cues of some mosquito species who interpret the breeding area into which it is leached to be rich in organic matter and therefore desirable for oviposition, are added in amounts 5%-10% by weight.

Cork and perlite are lighter than water and, when added in sufficient quantity, will keep the attractant/carrier afloat.

Activated charcoal absorbs compounds and releases them in a controlled manner. They can be added in amounts up to 25%, preferably 5%.

Formulation of a Composition by Diffusion:

The following is a preferred embodiment for the formulation of one such composition where the controlled release mechanism is predominantly by diffusion from a paraffin carrier. A typical formulation of the controlled release attractant is made by mixing paraffin in amounts from 10%-100%, preferably about 45%, depending on the type of wax and the desired properties of the coating, with about from 50% to 90% water, preferably about 30%. To formulate the composition, the paraffin is first heated under constant stirring, to the melting point temperature, typically from 40 degree C. to 80 degree C., preferably 50 degree C. depending on the type of paraffin used and water is then added. The attractant(s) are added directly to the molton carrier and the mixture is stirred. The composition is then cooled and stored as an aqueous emulsion, or the mixture is molded into any variety of forms. If used in a No Maintenance Lethal Mosquito Breeding Trap, cork shavings can be added to the composition before its molded in the shape of the familiar “life saver” candy and when floated inside the water container, releases the attractants to both the surrounding air and the water.

To attract gravid females of the vector Aedes aegypti to a “No Maintenance Lethal Mosquito Breeding Trap” for use in the United States, the above paraffin formulation may be used by adding the singular bio-active semiochemical (Z)-9-Hexadecenoic acid in a sufficient amount that will result in infusing the traps' water container with a concentration of 10 parts per million (ppm) for six months.

Using this same example to target the vector Culex quinquefasciatus, the above paraffin formulation may be used by adding the singular bio-active agent 3-methylindole to release from the carrier to achieve a concentration of up to 10 micrograms per liter of water in the water container for six months.

To entice both vectors Anopheles subpictus and Aedes aegypti in Pondicherry, India, to the same lethal trap, the above paraffin formulation may be used by adding pulverized powder from the shade dried fungus Polyporus spp. to yield a rinse of 4 ppm of water in the water container for an eight month period.

To add a pesticide to the above mentioned amalgamations, MALATHION PLUS™ made by the Ortho Group may be added to the molton carrier to achieve a concentration of 20 ppm in the water container for the associated periods of time.

To add a visual cue to the amalgamation, black ink may be added to the molton carrier in an amount of 1% to 10% by weight.

Formulation of a Composition by Degradation or Erosion:

If added to the MOSQUITO DUNK™ control device, that uses a floating amalgamation of cork and gypsum as a controlled release vehicle for the larvicide BTI and manufactured by the Summit Chemical Co., N.J., to target the vector Culex quinquefasiatus the compound 3-methylindole should be added to yield no more than 10 micrograms per liter of water in the target area for a maximum of three weeks. These compounds with the addition of a UV blocker such as beta-carotene or p-aminobenzoic acid in amounts between 1% and 3%, could be added in the manufacturing process outlined in U.S. Pat. No. 4,631,857 by I. E. Kase and P. L. Branton, dated Dec. 30, 1986 entitled “Floating article for improved control of aquatic insects” included herein by reference.

If added to the ALTOSID BRIQUET™ by Wellmark, International Co., to target the vector Aedes aegypti the semiochemical Tetradecanoic acid can be added during the manufacturing process outlined in U.S. Pat. No. 4,732,762 by R. D. Sjogren entitled “Timed release pest control composition and means” included here by reference, to yield a concentration of 1 ppm in the target area for a duration of thirty days. Carbonates can be added to the compound that will effervesce and carry the attractant to the surface.

Sources of Exotic Materials and Supplies:

Vector Control Research Laboratory, Pondicherry, India—Secondary metabolites of the fungus trichoderma viride and polyporus spp.

ISCA Technologies, Inc. Riverside, Calif.—The oviposition pheromone heterocyclie diasteroisomeric lactone mixture, (5R,6S)-hexadecanolide.

Berje Corporation, New Jersey—3-Methylindole

Some of the listed materials can also be synthesized by those familiar in the art. Other carriers and additives can be found from any well stocked chemical supply distributor, pharmacy and chemical manufacturers, through catalogs, and the internet.

### Additional Embodiments

The preferred embodiment described herein is to include the controlled release compositions for inclusion in a “No Maintenance Lethal Mosquito Breeding Trap” that is designed to function for one mosquito breeding season and then biodegrade, requiring a new device to be placed into service the following year. If such a trap were to be designed to function for longer than one mosquito breeding season, it is possible to design a controlled release attractant composition or a combination controlled release attractant composition and a pesticide that would function for a similar period of time. Also, the MOSQUITO DUNK™ and ALTOSID BRICKQUET™ and similar existing products that currently dispense a pesticide only, in a controlled release manner, could be reformulated to perform over much longer periods of time and, combined with the addition of the controlled release attractant compounds and additives detailed in this application, could function effectively for longer than one mosquito breeding season.

### CONCLUSION

Advantages:

From the description above, a number of advantages of my controlled release attractant become evident:
(a) Gravid female mosquitoes can be attracted to a source perceived to be a preferred breeding site where both she and her progeny can be eliminated.
(b) Controlled release attractants can be designed to perform over varying periods of time to coincide with the period of time an associated pesticide remains lethal.
(c) A controlled release attractant can be designed to attract specific species of mosquitoes including vectors of infectious and deadly diseases and are harmless to beneficial insects.
(d) Additives can be incorporated in a controlled release attractant amalgamation to add visual cues, pesticides, and buoyancy.
(e) By adding a controlled release attractant to existing mosquito control devices that currently only dispense a pesticide, they will perform at much higher efficiency and greater numbers of mosquito larva can be eliminated thereby reducing costs.
(f) A controlled release attractant can be designed that will perform for an entire mosquito breeding season or more with no tending or maintenance required.

Accordingly, the reader can see that the controlled release attractant described here can result in larger numbers of vector mosquitoes being eliminated thereby reducing human suffering and death. The financial resources saved by not having to treat as many victims of vector transmitted infectious disease, can be put to more utilitarian uses of improving the standards of living.

Accordingly, although the description above contains many specificities, these should not be construed as limiting the scope of the invention but merely providing illustrations of some of the presently preferred embodiments. Thus the scope of the invention should be determined by the appended claims and their legal equivalents, rather than by the examples given.

What I claim as my invention is:

1. A controlled release composition consisting of a carrier embedded with one or more substances known to attract gravid female mosquitoes and to induce them to deposit their eggs at site, said carrier and attracting substance(s) having a positive Ovipositional Active Index of 0.3 or greater and means for releasing said attractant for up to one year or more.

2. A controlled release attractant as described in claims 1, 9, and 10 that includes the following substance(s) either singly or in combination: the pheromone heterocyclic diasteroiomeric lactone mixture, (5R,6S)-hexadecanolide, 3-Methyl indole, lactone, epsilon-caprolactone, 6-hexanoloctone, 6-pentyl-alpha-pyrone, phenol, p-cresol, 4-ethylphenol, 4-methylphenol, indole, 3-methylindole, nonanal, 2-undecanone, 2-tridecanone, naphthalene, dimethyltrisulfide, dodecanoic acid, tetradecanoic acid, (Z)-9-hexadecanoic acid, hexadecanoic acid, (Z)-9-octadecanoic acid, o9ctadecanoic acid and n-heneicosane: the following bacteria/fungus group and their underlying chemical derivatives; enterobacter cloacae, acinitobacter calcoaceticus, psychrobacter immobilis, bacillus cereus, trichoderma viride, polyporus spp., aerobacter aerogenes, sphingobacterium multivorum, trichodermin, alamethicin, trichoviridin, and trichotoxin.

3. A controlled release attractant as described in claims 1, 9, and 10 wherein the carrier is selected from the group consisting of paraffin, carnauba wax, beeswax, candelilla wax, fruit wax, carbowax,
lanolin, shellac wax, bayberry wax, sugar cane wax, microcrystalline wax, ozocerite, ceresin, montan wax, polyethylene glycol, and combinations thereof.

4. A controlled release attractant as described in claims 1, 9, and 10 with means to be formed into various shapes.

5. A controlled release attractant as described in claims 1, 9, and 10 that is species specific.

6. A controlled release attractant as described in claims 1, 9, and 10 where the attractant may be made to remain buoyant.

7. A controlled release attractant as described in claims 1, 9, and 10 that can be added to existing mosquito control devices.

8. A controlled release attractant as described in claims 1, 9, and 10 that is biodegradable.

9. A controlled release composition consisting of a carrier embedded with one or more substances known to attract gravid female mosquitoes and induce them to deposit their eggs at site, said carrier and attracting substance(s) having a positive Ovipositional Active Index of 0.3 or greater and means for releasing said attractant for up to one year or more and combined with or otherwise associated with means for eliminating said eggs and preventing them from reaching maturity.

10. A controlled release composition consisting of a carrier embedded with one or more substances known to attract gravid female mosquitoes and induce them to deposit their eggs at site, said carrier and attracting substance(s) having a statistically significant positive attraction over a similar breeding site without an attracting substance, and means for releasing said attractant for up to one year or more.
